(19) United States
(12) Patent Application Publication
(10) Pub. No.: US 2014/0005977 A1
(43) Pub. Date: Jan. 2, 2014

(54) COMPUTER AND OBJECT TOLERANCE CALCULATION METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: HUNG-YI WU, New Taipei (TW); LEI LIU, Shenzhen (CN)

(21) Appl. No.: 13/927,226

(22) Filed: Jun. 26, 2013

(30) Foreign Application Priority Data
Jun. 27, 2012 (CN) 2012102149331

(51) Int. Cl. G01B 21/02

(52) U.S. Cl. CPC G01B 21/02
USPC 702/155

(57) ABSTRACT

A computing device provides a random number table. Formulas for calculating size differences between a first object and a second object are written to the random number table. The random number table is controlled to select random samples which are taken as an actual size of the first object and an actual size of the second object. According to a user's requirement, the random samples are selected many times. The computing device obtains an absolute value of size difference which is the most in the random number table. All actual maximum differences and all actual minimum differences corresponding to the obtained absolute value of size difference are obtained. The computing device selects a maximum value of the all actual maximum differences and a minimum value of the all actual minimum differences as a standard for manufacturing the first object and the second object.

### BACKGROUND

1. Technical Field

Embodiments of the present disclosure relate to object tolerance managing technology, and more particularly to a computer and a method of object tolerance calculation.

2. Description of Related Art

Presently, when an object is assembled with another object, there is a fit tolerance between the two objects. If a machine consists of a plurality of objects, there will be many fit tolerances between each two objects of the machine. The fit tolerances errors may propagate and increase the overall fit error of the machine. This is an inconvenience.

### BRIEF DESCRIPTION OF THE DRAWINGS

FIG. 1 is a block diagram of one embodiment of a computing device including a tolerance calculation system.

FIG. 2 is a schematic diagram illustrating one embodiment of assembling objects.

FIG. 3 is a block diagram of one embodiment of function modules of the tolerance calculation system in FIG. 1

FIG. 4 is a flowchart of one embodiment of object tolerance calculation method.

FIG. 5 is a table illustrating one embodiment of a random number table.

FIG. 6 is a graph illustrating one embodiment of absolute values of difference.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage system. Some non-limiting examples of non-transitory computer-readable media include CDs, DVDs, BLU-RAY, flash memory, and hard disk drives.

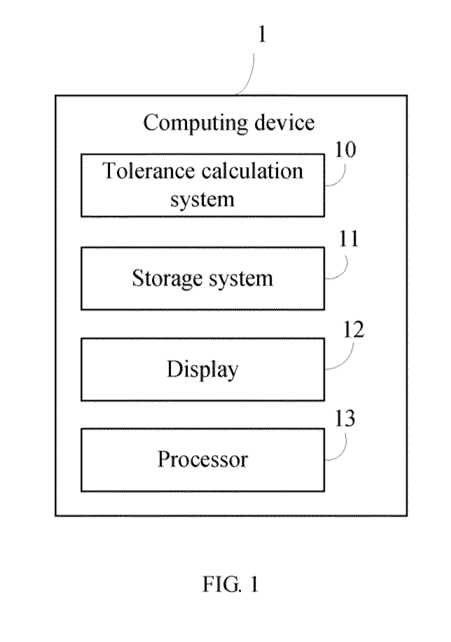

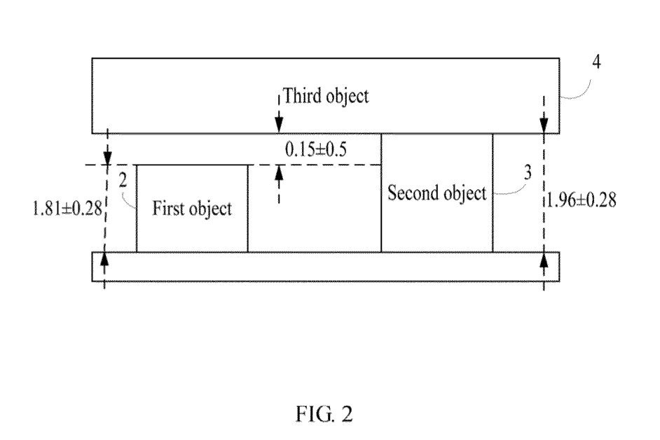

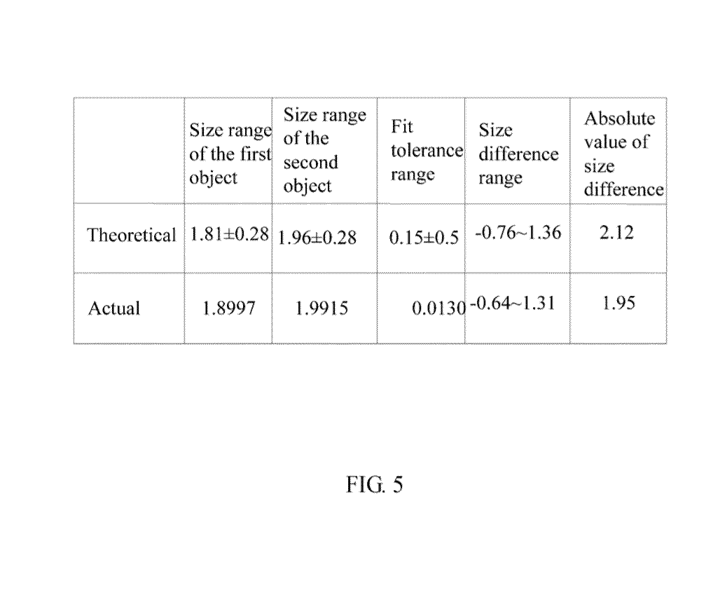

FIG. 1 is a block diagram of one embodiment of a computing device 1 including a tolerance calculation system 10. The computing device 1 further includes a storage system 11, a display 12, and a processor 13. In some embodiments, the storage system 11 is a dedicated memory, such as EPROM, a hard disk drive (HDD). The storage system 11 stores theoretical size values of a first object 2 and a second object 3 (as shown in FIG. 2). The theoretical size values may include a theoretical length, a theoretical width, a theoretical height of the first object 2, and a theoretical length, a theoretical width, a theoretical height of the first object 3. The storage system 11 also stores a theoretical tolerance of each theoretical size value and a theoretical fit tolerance range. The storage system 11 stores a random number table. In one embodiment, the random number table is a Monte Carlo random number table. As shown in FIG. 5, the random number table includes several columns, such as a first column records a size range of the first object 2, a second column records a size range of the second object 3, a third column records a fit tolerance range of assembling the first object 2, the second object 3 and the third object 4, a fourth column records a size difference range, and a fifth column records an absolute value of size difference between the first object 2 and the second object 3. The first column includes a theoretical size range and an actual size of the first object 2. The second column includes a theoretical size range and an actual size of the second object 3. The third column includes a theoretical fit tolerance range and an actual fit tolerance. The fourth column includes a theoretical size difference range and an actual size difference range. The fifth column includes a theoretical absolute value of size difference and an actual absolute value of size difference.

In one embodiment, the first object 2, the second object 3 and a third object 4 are three objects to be assembled together. In one embodiment, the first object 2 and the second object 3 are chips. The third object 4 is a radiator. The radiator should be assembled with the first object 2 and the second object 3. Due to different sizes of the first object 2 and the second object 3, the radiator cannot be assembled with the first object 2 or the second object 3. As shown in FIG. 2, the third object 4 is assembled above the first object 2 and the third object 4. Bottoms of the first object 2 and the third object 4 are on the same horizontal line. There is a height difference between the first object 2 and the third object 4. If the height difference is more than an allowable tolerance, the third object 4 cannot joint a surface of the first object 2, so that the third object 4 cannot assemble with the first object 2. The tolerance calculation system 10 calculates a minimum tolerance between the first object 2 and the second object 3 according to actual size values and theoretical size values of the first object 2 and the second object 3. The minimum tolerance helps the first object 2 and the second object 3 to be manufactured accurately.

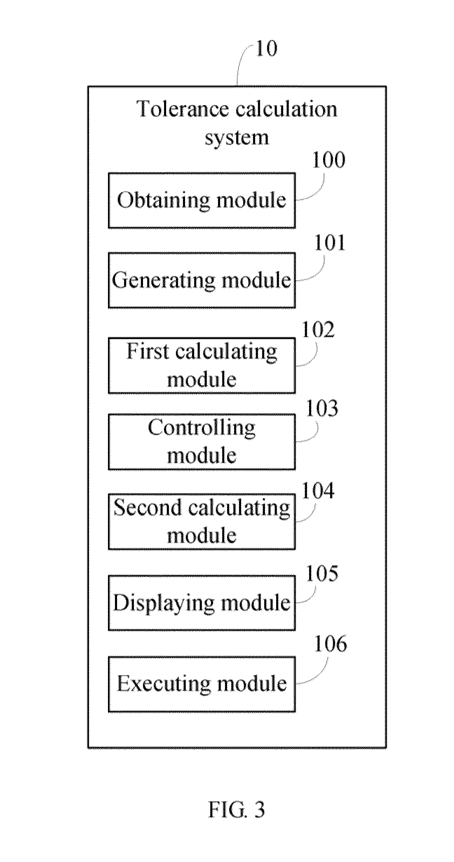

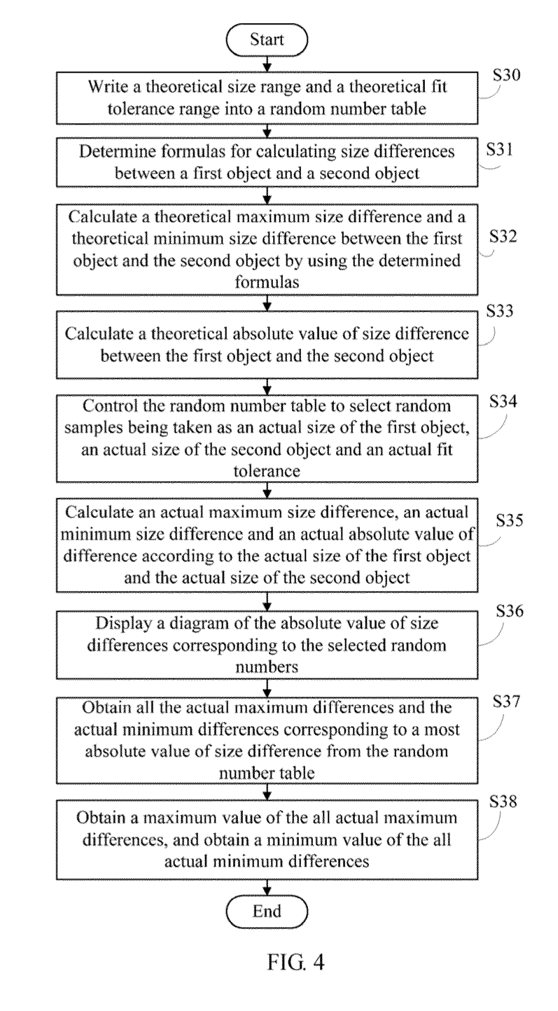

As shown in FIG. 3, the tolerance calculation system 10 includes a plurality of function modules, such as an obtaining module 100, a generating module 101, a first calculating module 102, a controlling module 103, a second calculating module 104, a displaying module 105 and an executing module 106. The modules 100-106 include computerized code in the form of one or more programs that are stored in the storage system 11. The computerized code includes instructions that are executed by the processor 13, to provide aforementioned functions of the tolerance calculation system 10. Detailed functions of the modules 100-106 are given in reference to FIG. 4.

FIG. 4 is a flowchart of one embodiment of object tolerance calculation method. Depending on the embodiment, additional steps may be added, others removed, and the ordering of the steps may be changed.

In step S30, the obtaining module 100 obtains the theoretical size values, the theoretical tolerance of each theoretical size value, and the theoretical fit tolerance range of the first object 2 and the second object 3 from the storage system 11. The obtaining module 100 further writes the theoretical size range and the theoretical fit tolerance range into the random number table according to the theoretical size values and the theoretical tolerance of each theoretical size value. For example, as shown in FIG. 2, in one embodiment, the theoretical fit tolerance range is set as 0.15±0.5 (mm) The theoretical height value of the first object 2 is set as 1.81 mm and the theoretical tolerance of the theoretical height value is set as ±0.28 mm.

The theoretical height value of the second object 3 is 1.96 mm and the theoretical tolerance of the theoretical height value is ±0.28 mm. Therefore, the theoretical height range of the first object 2 is 1.81±0.28 mm and the theoretical height range of the second object 3 is 1.96±0.28 mm.

In step S31, the generating module 101 determines formulas for calculating size differences between the first object 2 and the second object 3 according to positions between the first object 2, the second object 3 and the third object 4, and writes the determined formulas to the random number table. As shown in FIG. 2, the third object 4 should be assembled above the first object 2 and the second object 3. The first object 2 and the second object 3 are on the same horizontal line. A height difference between the first object 2 and the second object 3 has to be calculated. The generating module 101 determines formulas for calculating a maximum height difference, a minimum height difference and an absolute value of size difference. The maximum height difference includes a theoretical maximum height difference and an actual maximum height difference. The minimum height difference includes a theoretical minimum height difference and an actual minimum height difference. The formula for calculating the theoretical maximum height difference is the same for calculating the actual maximum height difference. The formula for calculating the theoretical minimum height difference is the same for calculating the actual minimum height difference.

In step S32, the first calculating module 102 calculates a theoretical maximum size difference and a theoretical minimum size difference between the first object 2 and the second object 3 by using the determined formulas according to the theoretical size ranges of the first object 2 and the second object 3 and the theoretical fit tolerance range in the random number table. As shown in FIG. 2, the theoretical maximum height difference is taken as the theoretical maximum size difference and the theoretical minimum height difference is taken as the theoretical minimum size difference. The theoretical maximum height difference=(1.96+0.28)+(0.15+0.5)−(1.81−0.28)=1.36 mm. The theoretical minimum height difference=(1.96−0.28)+(0.15−0.5)−(1.81+0.28)=−0.76 mm.

In step S33, the first calculating module 102 calculates a theoretical absolute value of a difference between the first object 2 and the second object 3 according to the theoretical maximum size difference and the theoretical minimum size difference. The theoretical absolute value of size difference=the theoretical maximum size difference+|the theoretical minimum size difference|. In FIG. 2, the theoretical absolute value of size difference =1.36+|−0.76|=2.12 mm.

In step S34, the controlling module 103 controls the random number table to select random samples from the theoretical size range of the first object 2, the theoretical size range of the second object 3 and the theoretical fit tolerance range. The selected random samples are taken as the actual size of the first object 2, the actual size of the second object 3 and the actual fit tolerance. The random samples can be selected more than once according to a user's requirement. For example, the random samples can be selected 1000 times. As shown in FIG. 5, the random number tables selects a value of “1.8997” as the actual size of the first object 2 and a value of “1.9915” as the actual size of the second object 3, and selects a value of “0.0130” as the actual fit tolerance range.

In step S35, the second calculating module 104 calculates an actual maximum size difference, an actual minimum size difference and an actual absolute value of size difference according to the actual size of the first object 2 and the actual size of the second object 3.

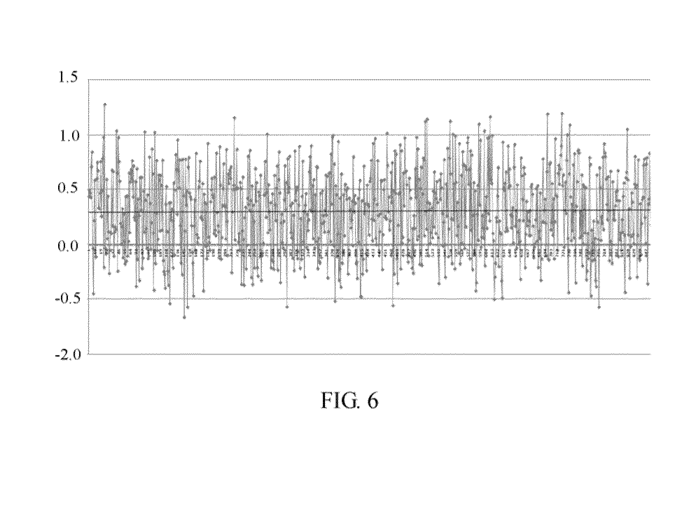

In step S36, the displaying module 105 displays a diagram of the absolute value of size differences corresponding to the selected random numbers, as shown in FIG. 6.

In step S37, the displaying module 105 obtains an absolute value of a difference which is displayed the most times on the diagram, and obtains all the actual maximum differences and the actual minimum differences corresponding to the obtained absolute value of size difference from the random number table. The absolute value of size difference corresponds to a plurality of actual maximum differences and the actual minimum differences.

In step S38, the executing module 107 obtains a maximum value of all actual maximum differences, and obtains a minimum value of all actual minimum differences. The actual maximum differences correspond to a plurality of values. The maximum value of all actual maximum differences is a value which is the maximal value of the actual maximum differences. The minimum differences correspond to a plurality of values. The minimum value of the actual minimum differences is the minimal value of the actual minimum differences. The maximum value is a maximum difference between the first object 2 and the second object 3 which are manufactured and assembled together. The minimum value is a minimum difference between the first object 2 and the second object 3 which are manufactured and assembled together.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device comprising one or more programs, which comprise instructions that are stored in a non-transitory computer-readable medium, when executed by a processor of the computing device, performs operations of:
(a) determining formulas for calculating size differences between a first object and a second object by the computing device according to positions between the first object, the second object and a third object which is assembled with the first object and the second object;
(b) calculating a theoretical maximum size difference and a theoretical minimum size difference between the first object and the second object by using the determined formulas, and calculating an absolute value of a difference between the first object and the second object according to the maximum size difference and the theoretical minimum size difference by the computing device;
(c) controlling a random number table to select random samples from a theoretical size range of the first object, a theoretical size range of the second object and a theoretical fit tolerance range, wherein the selected random samples are taken as the actual sizes of the first object, the actual sizes of the second object and the actual fit tolerances;
(d) calculating actual maximum size differences, actual minimum size differences and actual absolute values of size difference according to the actual sizes of the first object and the actual sizes of the second object;
(e) obtaining an absolute value of size difference which is the most in the random table and obtaining all the actual maximum differences and all the minimum differences corresponding to the obtained absolute value of size difference from the random number table; and
(f) obtaining a maximum value of all actual maximum differences and a minimum value of all actual minimum differences.

2. The computing device as claimed in claim 1, wherein before operation (a) further comprises operations of:
obtaining theoretical size values, theoretical tolerance of each theoretical size value, and the fit tolerance range of the first object and the second object from a storage system of the computing device;
calculating theoretical size ranges of the first object and the second object according to the theoretical size values and the theoretical tolerance of each theoretical size value of the first object and the second object; and
writing the theoretical size range and the theoretical fit tolerance range into the random number table.

3. The computing device as claimed in claim 1, wherein the operations further comprise:
displaying a diagram of the absolute values of differences corresponding to the selected random numbers.

4. A method being executed by a processor of a computing device, comprising steps:
(a) determining formulas for calculating size differences between a first object and a second object by the computing device according to positions between the first object, the second object and a third object which is assembled with the first object and the second object;
(b) calculating a theoretical maximum size difference and a theoretical minimum size difference between the first object and the second object by using the determined formulas, and calculating an absolute value of a difference between the first object and the second object according to the maximum size difference and the theoretical minimum size difference by the computing device;
(c) controlling a random number table to select random samples from a theoretical size range of the first object, a theoretical size range of the second object and a theoretical fit tolerance range, wherein the selected random samples are taken as the actual sizes of the first object, the actual sizes of the second object and the actual fit tolerances;
(d) calculating actual maximum size differences, actual minimum size differences and actual absolute values of size difference according to the actual sizes of the first object and the actual sizes of the second object;
(e) obtaining an absolute value of size difference which is the most in the random table and obtaining all the actual maximum differences and all the minimum differences corresponding to the obtained absolute value of size difference from the random number table; and
(f) obtaining a maximum value of all actual maximum differences and a minimum value of all actual minimum differences.

5. The method as claimed in claim 4, before step (a) further comprising:
obtaining theoretical size values, theoretical tolerance of each theoretical size value, and the fit tolerance range of the first object and the second object from a storage system of the computing device;
calculating theoretical size ranges of the first object and the second object according to the theoretical size values and the theoretical tolerance of each theoretical size value of the first object and the second object; and
writing the theoretical size range and the theoretical fit tolerance range into the random number table.

6. The method as claimed in claim 4, further comprising:
displaying a diagram of the absolute values of differences corresponding to the selected random numbers.

7. A non-transitory computer-readable medium having stored thereon instructions that, when executed by a processor of a computing device, cause the processor to perform operations of:
(a) determining formulas for calculating size differences between a first object and a second object by the computing device according to positions between the first object, the second object and a third object which is assembled with the first object and the second object;
(b) calculating a theoretical maximum size difference and a theoretical minimum size difference between the first object and the second object by using the determined formulas, and calculating an absolute value of a difference between the first object and the second object according to the maximum size difference and the theoretical minimum size difference by the computing device;
(c) controlling a random number table to select random samples from a theoretical size range of the first object, a theoretical size range of the second object and a theoretical fit tolerance range, wherein the selected random samples are taken as the actual sizes of the first object, the actual sizes of the second object and the actual fit tolerances;
(d) calculating actual maximum size differences, actual minimum size differences and actual absolute values of size difference according to the actual sizes of the first object and the actual sizes of the second object;
(e) obtaining an absolute value of size difference which is the most in the random table and obtaining all the actual maximum differences and all the minimum differences corresponding to the obtained absolute value of size difference from the random number table; and
(f) obtaining a maximum value of all actual maximum differences and a minimum value of all actual minimum differences.

8. The non-transitory computer-readable medium as claimed in claim 7, before step (a) further comprising:
obtaining theoretical size values, theoretical tolerance of each theoretical size value, and the fit tolerance range of the first object and the second object from a storage system of the computing device;
calculating theoretical size ranges of the first object and the second object according to the theoretical size values and the theoretical tolerance of each theoretical size value of the first object and the second object; and
writing the theoretical size range and the theoretical fit tolerance range into the random number table.

9. The non-transitory computer-readable medium as claimed in claim 7, further comprising:
displaying a diagram of the absolute values of differences corresponding to the selected random numbers.
